(19) United States
(12) Patent Application Publication
(10) Pub. No.: US 2026/0056150 A1
(43) Pub. Date: Feb. 26, 2026

(54) METHOD FOR ANALYZING A SAMPLE IN A CUVETTE

(71) Applicant: HOMBRECHTIKON SYSTEMS ENGINEERING AG, Hombrechtikon (CH)

(72) Inventors: Konstantin LUTZE, Uerikon (CH); Harald QUINTEL, Steckborn (CH)

(21) Appl. No.: 19/295,560

(22) Filed: Aug. 9, 2025

(30) Foreign Application Priority Data
Aug. 22, 2024 (EP) 24195974.1

(51) Int. Cl. G01N 23/2204; G01N 1/14

(52) U.S. Cl. CPC G01N 23/2204; G01N 1/14; G01N 2001/1418

(57) ABSTRACT

A method for analyzing a fluid sample by radiation. The method includes providing a cuvette having a cuvette body with an interior space for receiving the fluid sample, and an upper opening for filling and removing the fluid sample, and a lower opening for analyzing the fluid sample by the radiation, introducing the fluid sample into the interior space, irradiating the fluid sample with a primary radiation, and analyzing the fluid sample by receiving a secondary radiation originating from the fluid sample by a detection device.

### CROSS-REFERENCE TO RELATED APPLICATIONS

This application claims priority to European Application No. 24195974.1, filed Aug. 22, 2024, the contents of which are hereby incorporated by reference.

### TECHNICAL FIELD

The disclosure relates to a method for analyzing a fluid sample, a cuvette and a pipetting device for carrying out the method, and a laboratory machine.

### BACKGROUND

In the state of the art, analyses of liquid samples are carried out, inter alia, using a spectrometer or photometer or other optical detection devices. Such analyses take place, inter alia, in molecular-biological, biochemical, inorganic-chemical, organic-chemical and food-chemical applications.

Samples are optically analyzed, in particular, in research, in diagnostics and in quality control. They are analyzed, for example, by absorption, reflection, emission, fluorescence, Raman or luminescence spectroscopy in the UV-VIS or IR wavelength range. In this case, inter alia, biomolecules such as nucleic acids, proteins, lipids and inorganic or organic substances and compounds are analyzed.

In this case, cuvettes which are used in detection devices such as in absorption photometers are frequently used for analyzing the liquid samples. For the analysis, the liquid samples are filled into the interior space of the cuvettes, which generally have a measurement range. Absorption photometers can measure, for example, the transmission and absorption (extinction) of a sample. Conclusions about the qualitative or quantitative composition of the sample and concentrations can be drawn from the measurement of these variables. The radiation used in the analysis in cuvettes lies, in particular, in the range of visible light, in the IR or UV range. In this case, the selection generally depends on the fluid sample to be analyzed. The material selection of the cuvette depends on the wavelength range of the radiation used. The wavelength range can be selected by color filters or interference filters, or by the light of an irradiation device being decomposed by a monochromator.

An essential field of use for cuvettes is the analysis of samples in small amounts, since often only small amounts of sample (for example 1 to 5 microliters) are available, because it is not possible to provide a larger amount of the sample. A known application in this case is the analysis of nucleic acid concentrations before a PCR or real-time PCR, in order to be able to use the starting amount of the nucleic acid which is optimal for the PCR.

A further example is the measurement of the concentration of biomolecules, which is carried out by fluorescence markers. In particular in the case of biomolecules, luminescence spectroscopy is an important analysis method in which the emission light which arises on the basis of a photon absorption of the biomolecules is evaluated. In particular, fluorescent chemical groups which then serve as markers for this biomolecule can be attached to large biomolecules for this purpose by a fluorescence labeling.

In many processes, in particular the concentration of the fluid samples (that is to say of the relevant molecules in solution) plays a role for further processing, which can be determined easily, in particular, by fluorescence spectroscopy. The optical density (measure for the attenuation of a radiation after passing through a medium) can also be used for determining the concentration.

### SUMMARY

Standard cuvettes are suitable for use in the cuvette shafts of most common spectrometers and photometers and have a cross section of 12.5 mm×12.5 mm for this purpose. The path length for the radiation is generally around 10 mm. However, for small amounts of sample, there are microcuvettes which have a path length of 0.2 to 1 mm and are filled with only a few microliters.

Single-use cuvettes are usually composed of materials such as polystyrene or polymethyl methacrylate which have an optimal permeability for radiation having a wavelength of 250 to 800 nm. Reusable cuvettes are generally composed of borosilicate glass or quartz glass.

It is problematic that the cuvettes have to be used for analysis in cuvette shafts, or the cuvettes have to be at least singulated. In addition, recovery of precious samples after the measurement is not possible without the risk of contamination.

When processing a large number of samples, a large number of processing steps have to be carried out in order to enable the analysis. The analysis of the fluid samples in the detection devices is therefore generally very time-consuming and not very flexible.

The object of the disclosure is therefore to provide a method for analyzing a fluid sample, a cuvette and a pipetting device for carrying out the method, and a laboratory machine, which avoid the disadvantageous effects known from the state of the art. In particular, a flexible and/or rapid analysis of fluid samples is to be enabled.

The object is achieved by a method for analyzing a fluid sample, a cuvette and a pipetting device for carrying out the method, and a laboratory machine having the features described herein.

The disclosure relates to particularly advantageous embodiments.

According to the disclosure, a method for analyzing a fluid sample by radiation is proposed. In this case, a cuvette comprising a cuvette body with an interior space for receiving the fluid sample, and an upper opening for filling and removing sample liquid such as the fluid sample, and a lower opening for analyzing the fluid sample by the radiation is provided. The fluid sample is introduced into the interior space of the cuvette body or the cuvette and the fluid sample is irradiated with a primary radiation. In addition, the fluid sample is analyzed by receiving a secondary radiation originating from the fluid sample via the lower opening and/or the upper opening by a detection device.

By using an upper and lower opening in the analysis, in particular a simple sample recovery is ensured, and flexible processing is enabled.

In an exemplary embodiment of the disclosure, the detection device is arranged at the lower opening in such a way that the secondary radiation is received through the lower opening. In this case, the cuvette can be irradiated from the side by a radiation source, so that, for example, the scattering from below can be observed by the detection device. For this purpose, the lower opening can be arranged at a base surface of the cuvette. In addition, a lateral wall of the cuvette body can have a measurement window, through which the irradiation takes place. Alternatively, for an absorption measurement, irradiation can take place from above.

The radiation source and the detection device can thus be separate devices but can also be integrated into one device. In particular, the radiation source can thus be a part of the detection device. In this case, the analysis can comprise irradiating the fluid sample with the primary radiation by the radiation source of the detection device and receiving the secondary radiation originating from the fluid sample by a detector of the detection device. In the analysis, in particular a concentration of the fluid sample can be determined by the secondary radiation.

In one embodiment of the disclosure, the cuvette or at least a part of the cuvette (such as, for example, a measurement range of the cuvette) can be optically transparent. For this purpose, the cuvette or the part of the cuvette can consist of an amorphous polymer or comprise an amorphous polymer. The cuvette can comprise, in particular, a plastic, in particular consist of cycloolefin copolymer. Cycloolefin copolymers are generally obtained by metallocene-catalyzed copolymerization of cycloolefins with alk-1-enes. In contrast to semicrystalline polymers such as polyethylene and polypropylene, cycloolefin copolymers are amorphous and thus optically transparent. Due to the low birefringence and optical transparency, the cycloolefin copolymers can be used particularly preferably for an optical analysis (using the detection device). Alternatively, the materials known in the state of the art mentioned above can also be used.

Within the scope of the disclosure, optically transparent means that the cuvette (at least in a region of the measurement window) is permeable to electromagnetic waves/radiation, in particular to electromagnetic waves/radiation in the UV/VIS range and/or NIR range or to the primary radiation.

In a further embodiment of the disclosure, the fluid sample can be introduced into the interior space of the cuvette body or the cuvette, wherein, however, a dye (such as a fluorescence marker known in the state of the art) has already been introduced into the interior space. However, the cuvette could also be prefilled with any reagent, in particular a lyophilized reagent. In this case, a kinetic reaction can be observed, or the fluorescence can be analyzed during the mixing in order to check whether mixing is complete (if the signal no longer changes).

Within the scope of the disclosure, the term “fluid sample” can be understood to mean, in particular, a sample which comprises a liquid with substances such as biomolecules (inter alia DNA, RNA, nucleic acids, proteins, cells and cell constituents, monomers) or other chemical substances. Within the scope of the disclosure, a liquid can be, for example, a suitable solvent which comprises, in particular, water.

As mentioned above, the detection device can comprise a radiation source for irradiating the fluid sample with a primary radiation and a detector for receiving a secondary radiation originating from the fluid sample (for analyzing the fluid sample). The radiation source therefore generates an electromagnetic radiation (the primary radiation). The secondary radiation is, in particular, an electromagnetic secondary radiation emitted/originating from the fluid sample, which secondary radiation is induced by an interaction of the primary radiation with the fluid sample.

In this case, particularly preferably UV/VIS radiation and/or NIR radiation, in particular in the wavelength range of 190-1200 nm, in particular 190-1000 nm, in particular 365-720 nm is used as primary radiation. In this case, in particular, a diode, in particular a silicon photodiode or a vacuum photodiode is suitable as detector. A laser, a deuterium lamp, a tungsten lamp, a halogen lamp, a mercury vapor lamp or an LED (light-emitting diode) can be used as radiation sources.

However, it is also possible for the radiation source to be normal light such as sunlight, by which the sample is analyzed. In this case, the detection device can particularly preferably be a camera. The camera can be used, for example, to analyze a fluid sample with cells, wherein a movement of the cells, in particular a sinking of the cells onto a carrier, is observed. In this case, the carrier can be arranged at the lower opening (preferably at the base of the cuvette), wherein the cells settle on the carrier. However, adhesion of cells or other analytes can also be observed.

In practice, the detection device can also comprise a large number of detectors and/or radiation sources. In this case, the radiation sources can emit different wavelengths or wavelength ranges as primary radiation. Particularly preferred in this case is the use of two radiation sources which are configured as a first radiation source (preferably first LED) having a first wavelength (e.g. 450-490 nm) and a second radiation source (preferably second LED) having a second wavelength (e.g. 600-630 nm). If a large number of radiation sources are present, the analysis can be carried out confocally. The beam paths of the primary radiation from the different radiation sources are therefore directed to a common focal point in the fluid sample.

The detection device can also be, in particular, a photometer, in particular a spectrometer, specifically a fluorometer. The fluorometer measures the parameters of the fluorescence of the fluid sample: intensity and wavelength distribution of the emission spectrum (of the secondary radiation) after excitation by the primary radiation.

Within the scope of the disclosure, however, an absorption measurement can also particularly preferably be used as measurement principle, wherein the radiation source generates primary radiation in the UV/VIS range and/or NIR range (in particular of a single wavelength, such as e.g. 280 nm) and the light beam (secondary radiation) attenuated by the passage through the sample and the extension is detected by the detector. In this case, the extinction or optical density (measure for the attenuation of the primary radiation in a medium (sample and extension)) is preferably used to characterize the absorption intensity. For this purpose, the detection device can be arranged at the upper opening in such a way that the secondary radiation is received through the upper opening. The radiation source can then be arranged at the opposite lower opening and irradiate the fluid sample. Of course, an inverse arrangement is also possible.

In one embodiment of the disclosure, a plurality of cuvettes can be provided, and the plurality of cuvettes is arranged in a holder for analysis, wherein the detection device is guided from below to the plurality of cuvettes in such a way that the secondary radiation is received through the lower opening. In this case, in particular, the irradiation can also take place from below. This makes it possible for a large number of samples to be easily analyzed (in particular also at the same time) without a time-consuming separation and introduction into a detection device being necessary.

The holder can comprise a carrier element permeable to the radiation, and the cuvette can be arranged with the lower opening on the carrier element in such a way that the detection device for receiving the secondary radiation is arranged at the carrier element. The carrier element can correspond to the above-mentioned carrier and, in particular, can be an optically transparent object slide.

In one embodiment of the method according to the disclosure, the cuvette for introducing the fluid sample into the interior space can be arranged with the upper opening at a pipetting device and the fluid sample can be introduced into the interior space by the pipetting device. In this case, the cuvette (in particular the cuvette body) can also have a receiving element at the upper opening, by which the cuvette can be removably attached to the pipetting device (in particular an adapter for pipette tips of the pipetting device) or a pipette tip. A transport of the cuvette by the pipetting device is thus enabled. Alternatively, the cuvette can also be received on the receiving element by a transport device. The cuvette can be moved to the detection device by the pipetting device or the transport device. Alternatively, the cuvette can be received on the receiving element by the detection device and/or the radiation source in order to irradiate and/or analyze from above.

In practice, the fluid sample can be held in the interior space by a pressure or a capillary force (so that it does not flow away through the lower opening). The pressure can be generated by a device such as a pump or the pipetting device.

According to the disclosure, a cuvette for carrying out the method according to the disclosure is also proposed. In this case, the cuvette comprises the cuvette body with the interior space for receiving the fluid sample, and the upper opening for filling and removing sample liquid and the lower opening for carrying out the analysis of the fluid sample by the radiation. The lower opening can be arranged at the base (in particular a support surface) of the cuvette body or at a side wall/a side of the cuvette body.

The cuvette can comprise a mirror element which is arranged at the cuvette body in such a way that the primary radiation and/or secondary radiation can be reflected. The mirror element can particularly preferably be used in combination with the camera, so that the side surface of the cuvette can also be observed at the same time using the same camera.

According to the disclosure, a pipetting device for carrying out the method according to the disclosure is also proposed. The pipetting device comprises an adapter for receiving the cuvette and a displacement element which can be flow-connected to the cuvette for generating a flow for receiving and/or ejecting the fluid sample.

In a further embodiment of the method according to the disclosure, the cuvette can then be arranged at the pipette tip and the fluid sample can be received/introduced into the cuvette for analysis.

The cuvette can be removably arranged at the pipette tip in such a way that the cuvette is flow-connected to the displacement element via the pipette tip, so that the fluid sample can be received into the cuvette and/or ejected from the extension by the flow which can be generated by the displacement element.

Within the scope of the disclosure, the fact that the pipette tip is flow-connected to the displacement element can be understood to mean, in particular, that a tip interior space of the pipette tip (which is suitable for receiving a liquid or the fluid sample) is connected to the displacement element in such a way that, by actuation thereof, a flow connection to the cuvette can be established via the tip interior space (or the fluid sample or a liquid can be received into the tip interior space if the cuvette is not arranged at the pipetting device). Within the scope of the disclosure, the fact that the cuvette is flow-connected to the displacement element via the pipette tip can be understood to mean, in particular, that the interior space of the cuvette (which is also suitable for receiving the liquid or the fluid sample) is connected to the tip interior space in such a way that, by actuation of the displacement element, the fluid sample (or the liquid) can be received into the interior space because a flow connection to the displacement element is present via the tip interior space.

Within the scope of this application, the term “removable” can be understood to mean that both the pipette tip and the cuvette are not fixedly fastened but rather can be easily removed and can thus be easily removed and disposed of, in particular as a single-use pipette tip/cuvette.

The pipette tip can comprise a specially shaped fastening region at which the cuvette can be sealingly arranged at the pipette tip.

In addition, the cuvette can have a measurement region which can be specially shaped, wherein, in particular, a cross-sectional profile of the measurement region is rectangular or square. In this case, the cuvette can have the mass of a standard cuvette known in the state of the art.

According to the disclosure, a laboratory machine for processing a fluid sample is also proposed, wherein the laboratory machine comprises a treatment space for receiving the cuvette, the pipetting device. Furthermore, the pipetting device is arranged in the treatment space for carrying out at least one processing step on the fluid sample, and the laboratory machine comprises a movement device which is arranged so as to be movable in at least one first spatial direction of the treatment space, which movement device is connected to the pipetting device in such a way that the pipetting device can be moved through the treatment space by the movement device. In addition, the detection device for analyzing the fluid sample is arranged in the treatment space, and the laboratory machine has an electronic control device which is signal-connected to the pipetting device, the movement device and the detection device.

In practice, a container for receiving the fluid samples is generally arranged in the treatment space. In particular, the container can be a microtiter plate, wherein the microtiter plate comprises a plurality of depressions for receiving the fluid samples (or different fluid samples).

In practice, the pipetting device can have an ejection device known from the state of the art with a drive device and an ejector, in order to eject the pipette tips by actuating the drive device, by the ejector being displaced in such a way that it releases the pipette tip from the receiving element without the pipette tip having to be touched by the user. In addition, the ejection device can have a cuvette ejector, in order to eject the cuvette by actuating the drive device, by the cuvette ejector being displaced in such a way that it releases the cuvette from the pipette tip without the pipette tip having to be touched by the user. For this purpose, the cuvette ejector can be configured as a sleeve which moves around the pipette tip to the cuvette and which has such a larger radius than the pipette tip and has such a smaller radius than the cuvette that only the cuvette is ejected. In addition, the cuvette ejector could comprise a gripping mechanism which fixes the pipette tip during ejection of the cuvette. The cuvette ejector enables the pipette tip to be used for further steps after ejection of the cuvette.

The fact that the electronic control device is signal-connected to the pipetting device, the movement device and the detection device means that, in the operating state, the control device sends control signals for carrying out the processing steps to the pipetting device, the movement device and the detection device. In addition, signals can also be received from the pipetting device, the movement device and the detection device.

The signal connection can take place via a cable connection or wirelessly. In the case of the wireless signal connection, the data/signal transmission takes place via free space (air or vacuum) as transmission medium. The transmission can take place by directional or non-directional electromagnetic waves, whereby a range of the frequency band to be used can vary from a few Hertz (low frequency) to several hundred terahertz (visible light), depending on the application and technology used. Bluetooth or WLAN is preferably used in this case. Thus, not only the detection device can be controlled by the control device, but, after the analysis of the fluid samples, the measured data can be transmitted to the control device for evaluation in order, for example, to determine a concentration of the fluid sample before further processing.

### BRIEF DESCRIPTION OF THE DRAWINGS

The disclosure set s forth exemplary embodiments with reference to the drawings. The drawings show:

FIG. 1 is a schematic illustration of a cuvette according to the disclosure;

FIG. 2 is a schematic illustration of a laboratory machine according to the disclosure;

FIGS. 3A and 3B are schematic illustrations of method steps of the method according to the disclosure;

FIGS. 4-6 are schematic illustrations of a detection of the method according to the disclosure.

### DETAILED DESCRIPTION

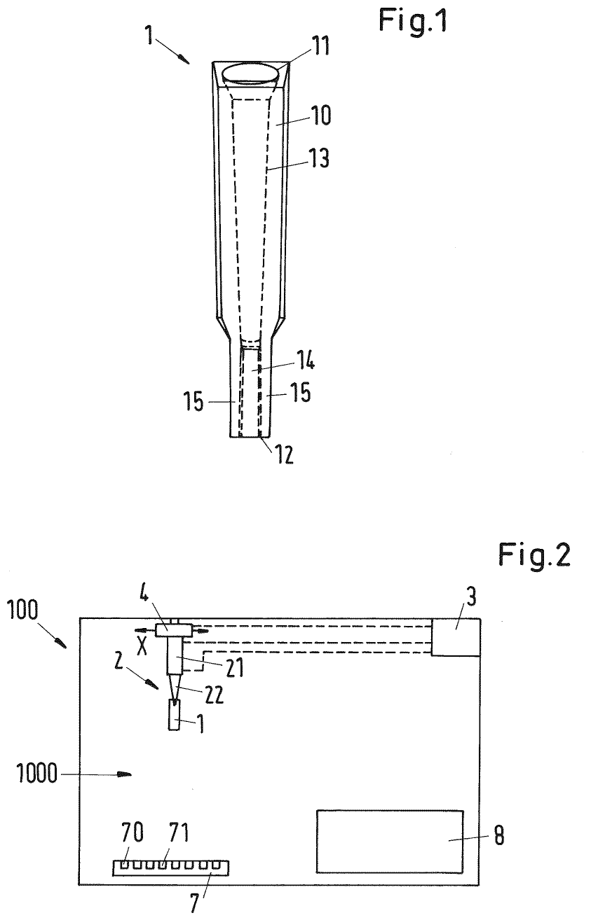

FIG. 1 shows a schematic illustration of a cuvette 1 for carrying out the method according to the disclosure.

The cuvette 1 has a cuvette body 10 with an interior space 14 for receiving a fluid sample. In addition, the cuvette 1 has an upper opening 11 for filling and removing sample liquid and a lower opening 12 for analyzing the fluid sample by radiation. The lower opening 12 is arranged at a base surface of the cuvette 1.

In the method according to the disclosure, the fluid sample is introduced into the interior space 14 via the upper or lower opening. The lower section of the cuvette with parallel walls 15 (configured here as a measurement window) is in this case the measurement region of the cuvette 1.

In addition, the cuvette 1 has a receiving element 13 at the upper opening 11 (extends from the upper opening 11 downwards into the interior space 14), by which the cuvette 1 can be arranged at a pipette tip or detection device. For this purpose, the receiving element 13 is configured as a conically tapering inner wall of the cuvette body 10.

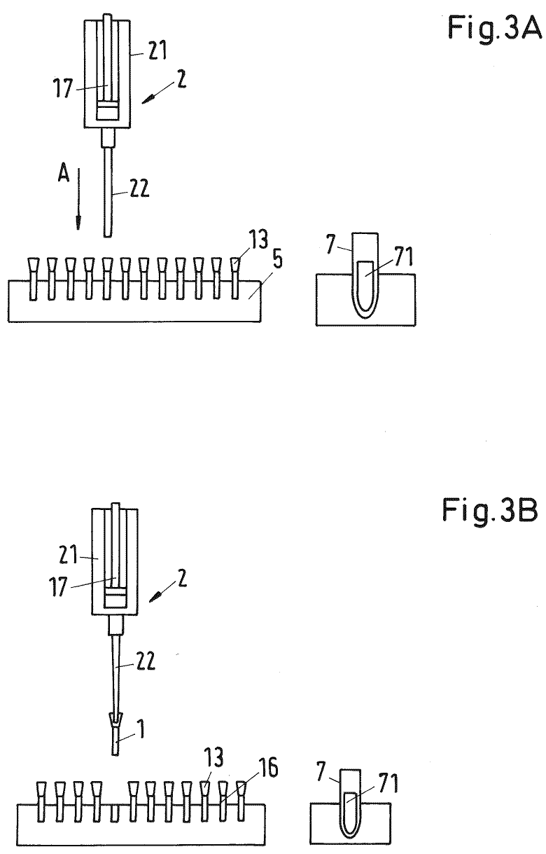

FIG. 2 shows a schematic illustration of a laboratory machine 100 according to the disclosure.

The laboratory machine 100 for processing a fluid sample 71 comprises a treatment space 1000 for receiving the fluid sample 71 and a pipetting device 2 according to the disclosure, which pipetting device 2 is arranged in the treatment space 1000 for carrying out at least one processing step on the fluid sample 71.

The pipetting device 2 for processing the fluid sample 71 comprises in this case an adapter 21 and a pipette tip 22 which is removably arranged at the adapter 21 and a displacement element (which is integrated into the adapter 21) which is flow-connected to the pipette tip 12 for generating a flow for receiving and/or ejecting the fluid sample 71.

Furthermore, the pipetting device 2 comprises the cuvette 1, which is removably arranged at the pipette tip 22 in such a way that the cuvette 1 is flow-connected to the displacement element via the pipette tip 22, so that the fluid sample 71 can be received into the cuvette 1 and/or ejected from the cuvette 1 by the flow which can be generated by the displacement element.

The receiving/ejection can take place via the upper opening of the cuvette 1 by the fluid sample 71 being dispensed from the pipette tip 22 or received into the pipette tip 22. In addition, the fluid sample 71 can also be received directly into the lower opening of the cuvette 1 or dispensed thereover by the flow connection.

In addition, the laboratory machine 100 comprises a movement device 4 which is arranged so as to be movable in at least one spatial direction X of the treatment space 1000. This movement device 4 is connected to the pipetting device 2 in such a way that it can be moved through the treatment space 1000 by the movement device 4. Furthermore, a detection device 8 for analyzing the fluid sample 71 and an electronic control device 3, which is signal-connected to the pipetting device 2, the movement device 4 and the detection device 5, are arranged in the treatment space 1000. In addition, a container 7 with a plurality of depressions 70 for receiving the fluid samples 71 is located in the treatment space 1000.

The cuvette 1 can be optically transparent, since a lateral irradiation of the fluid sample 71 in the cuvette 1 is thus enabled. For this purpose, the cuvette can be inserted into the detection device 8 (which also comprises a radiation source for a primary radiation). In principle, however, the cuvette 1 can also be arranged above the detection device 8 (with radiation source). The fluid sample in the interior space of the cuvette 1 is irradiated with the primary radiation from below via the lower opening and a secondary radiation originating from the fluid sample 71 is likewise detected via the lower opening. In this case, the cuvette 1 does not have to be optically transparent. The material selection is therefore flexible, and a cost-effective selection of the material is possible. Thus, for example, an analysis can be carried out via detection of the fluorescence radiation as secondary radiation.

The steps for processing/analyzing (method) the fluid sample 71 are controlled by the electronic control device 3 which is signal-connected to the pipetting device 1, the movement device 4 and the detection device 8. The electronic control device 3 thus prescribes that the fluid sample 71 is received into the cuvette 1 by actuation of the displacement mechanism and is introduced into the detection device 8/guided to the detection device 8 for analysis using the cuvette 1, so that the fluid sample 71 can be analyzed in the cuvette 1.

In the operating state, the control device 3 can therefore send control signals for carrying out different processing steps to the pipetting device 2, the movement device 4 and the detection device 8. Of course, the control device 3 can also receive signals from the pipetting device 2, the movement device 4 and the detection device 8. The signal connection is indicated by the dashed lines.

After the analysis of the fluid samples 71, the measured data are transmitted from the detection device 8 to the control device 3 for evaluation.

Alternatively, the reference numbers 21, 22 can also represent a detection device (in particular with a radiation source or camera), wherein no further detection device is necessary in the treatment space 1000.

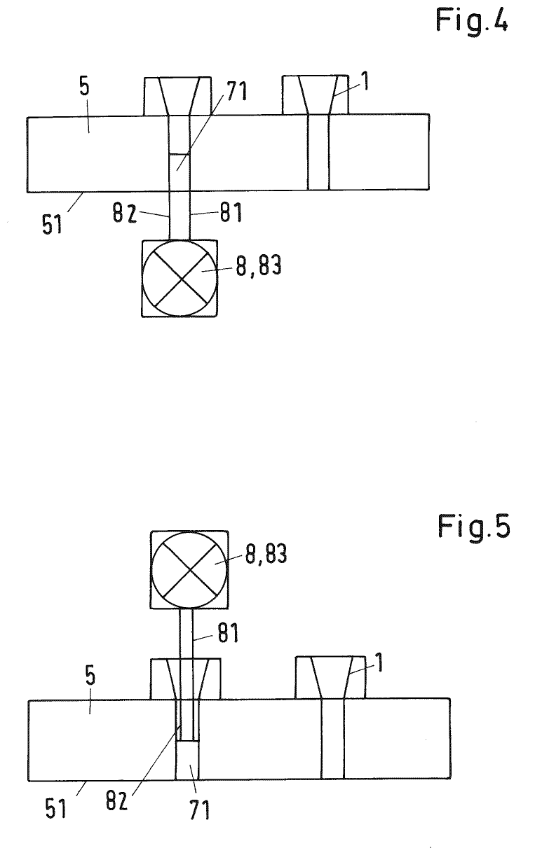

FIGS. 3A and 3B show a schematic illustration of steps of the method according to the disclosure.

The pipetting device 2 according to FIGS. 3A and 3B comprises in this case the adapter 21 and a pipette tip 22 which is removably arranged at the adapter 21. The displacement element 17 for generating the flow for receiving and/or ejecting the fluid sample 71 (illustrated here in a storage container 7) is integrated into the adapter 21 and is thus flow-connected to the pipette tip 22. The displacement element 17 is configured as a displaceable piston which generates the flow in the form of an air cushion displacement by movement along an ejection axis A.

In FIG. 3B, the cuvette 1 is applied to the pipette tip 22. For this purpose, the cuvette 1 comprises the receiving element 13 into which the pipette tip 22 is introduced, as a result of which the cuvette 1 is received from the storage/holder 5 by the pipetting device 2.

In addition, the cuvette 1 comprises a measurement range 16 which is arranged at the receiving element 13, at which measurement range 16 the analysis of the fluid sample 71 is carried out later.

The fluid sample 71 can either be dispensed from the pipette tip 22 into the cuvette 1 (via the upper opening) or received from the storage container 7 directly into the cuvette (via the lower opening).

In contrast to the method steps according to FIG. 3B, the cuvette 1 in FIG. 3A is not received by the pipette tip 22, but rather the pipetting device 2 is guided to the cuvette 1. The fluid sample 71 is then introduced from the pipette tip 22 into the interior space of the cuvette 1 via the upper opening of the cuvette 1. The analysis can then be carried out.

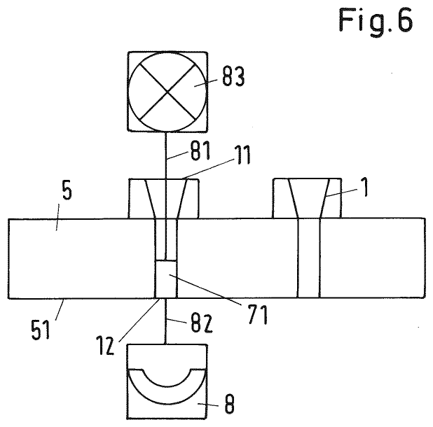

FIGS. 4 to 6 show a schematic illustration of a detection of the method according to the disclosure. The cuvette 1 or the plurality of cuvettes 1 is arranged in a holder 5.

In this case, the radiation source 83 is used for irradiating the fluid sample 71 with a primary radiation 81 and the detection device 8 is used for receiving a secondary radiation 82 originating from the fluid sample 71.

In FIG. 6, the radiation source 83 is present separately, radiation being emitted through the upper opening 11 and lower opening 12. Of course, an inverse arrangement of radiation source 83 and detection device 8 is also possible in FIG. 6.

In FIGS. 4 and 5, the radiation source 83 is integrated into the detection device 8.

The fluid sample 71 is therefore irradiated with the primary radiation 81 by the radiation source 83 and the detection device 8 receives the secondary radiation 82 originating from the fluid sample 71.

The radiation source 83 generates the primary radiation 81 preferably as an electromagnetic radiation in the UV/VIS range, in particular in the wavelength range of 190-1200 nm, in particular 365-720 nm. The secondary radiation 82 is, in particular, an electromagnetic secondary radiation 82 originating from the fluid sample 71, which secondary radiation 82 is induced by an interaction of the primary radiation 81 with the fluid sample 71.

In FIG. 6, the cuvette 1 has the upper and lower opening 11, 12. In FIG. 6, an absorption measurement is used as measurement principle, wherein the light beam 82 (secondary radiation) attenuated during the passage through the sample 71 is detected at the lower opening 12 by the detection device 8.

The cuvette 1 can, in particular, be optically transparent, since a lateral irradiation or transmission of the fluid sample 71 in the cuvette 1 is thus enabled.

In FIGS. 4 and 5, a fluorescence measurement can be used as measurement principle, wherein the fluorescence radiation 82 of the sample 71 is detected by the detection device 8 after irradiation of the fluid sample 71 with the primary radiation 81.

For this purpose, the detection device 8 is arranged at the lower opening below the cuvette 1. As a result of the fact that the irradiation and detection can take place at the lower opening/one opening, it is avoided that the radiation has to radiate through the cuvette material. A more precise analysis, in particular with higher radiation intensity, is thus enabled.

In FIG. 4, the fluid sample 71 in the interior space of the cuvette 1 is irradiated with the primary radiation 81 from below via the lower opening and the secondary radiation 82 originating from the fluid sample 71 is likewise detected via the lower opening.

Alternatively, in the construction according to FIG. 4, a camera can also be used as detection device 8. The primary radiation 81 is then normal light and the holder 5 comprises a transparent carrier 51, on which the cuvette 1 with the lower opening is placed. In this case, it is possible, for example, to observe how cells settle on the carrier 51. The use of a camera is also possible in FIG. 5 or 6, wherein, when an endoscope camera is used, the endoscope camera can also be introduced into the cuvette from above.

The disclosure is not restricted to the disclosed embodiments. Other variations of the disclosed embodiments can be understood and brought about by persons skilled in the art when practicing a claimed disclosure from a study of the drawings, the disclosure and the dependent claims. In particular, all the embodiments and designs described above can be combined with one another. In addition, detection devices known in the state of the art can be used for analysis. In the claims, the word “comprising” does not exclude any other elements or steps, and the indefinite article “a” or “an” does not exclude a plurality. The mere fact that certain measures are repeated in dependent claims which differ from one another does not mean that a combination of these measures cannot be advantageously used. Any reference numbers in the claims should not be interpreted as restricting the scope.

What is claimed:

1. A method for analyzing a fluid sample by radiation, comprising:
providing a cuvette comprising
a cuvette body with an interior space to receive the fluid sample, and
an upper opening to fill and remove the fluid sample, and
a lower opening to analyze the fluid sample by the radiation;
introducing the fluid sample into the interior space;
irradiating the fluid sample with a primary radiation; and
analyzing the fluid sample by receiving a secondary radiation originating from the fluid sample via the lower opening or the upper opening by a detection device.

2. The method according to claim 1, wherein the detection device is arranged at the lower opening such that the secondary radiation is received through the lower opening.

3. The method according to claim 1, wherein the detection device is arranged at the upper opening such that the secondary radiation is received through the upper opening.

4. The method according to claim 1, wherein the cuvette is one of a plurality of cuvettes, and the plurality of cuvettes is arranged in a holder for analysis, the detection device is guided from below to the plurality of cuvettes such that the secondary radiation is received through the lower opening.

5. The method according to claim 4, wherein the holder comprises a carrier element permeable to the radiation, and the plurality of cuvettes are arranged with the lower opening on the carrier element such that the detection device for receiving the secondary radiation is arranged at the carrier element.

6. The method according to claim 1, wherein the cuvette is arranged with the upper opening on a pipetting device for introducing the fluid sample into the interior space and the fluid sample is introduced into the interior space by the pipetting device.

7. The method according to claim 1, wherein the cuvette body comprises a receiving element at the upper opening, and the cuvette is received at the receiving element by a transport device.

8. The method according to claim 6, wherein the cuvette is moved to the detection device by the pipetting device.

9. The method according to claim 1, wherein the fluid sample is held in the interior space by a pressure or a capillary force.

10. The method according to claim 1, comprising determining a concentration of the fluid sample by the secondary radiation.

11. The cuvette for carrying out the method according to claim 1, comprising:
the cuvette body with the interior space to receive the fluid sample, and the upper opening to fill and remove the fluid sample, and
the lower opening to carry out analysis of the fluid sample by the radiation.

12. The cuvette according to claim 11, wherein the lower opening is arranged at a base of the cuvette body.

13. The cuvette according to claim 11, wherein the lower opening is arranged at a side wall of the cuvette body.

14. The cuvette according to claim 11, further comprising a mirror element arranged at the cuvette body such that the primary radiation or the secondary radiation is capable of being reflected.

15. The method according to claim 1, wherein the cuvette body comprises a receiving element at the upper opening, and the cuvette is received at the receiving element by a pipetting device.

16. The method according to claim 1, wherein the cuvette body comprises a receiving element at the upper opening, and the cuvette is received at the receiving element by a pipette tip of a pipetting device.

17. A pipetting device for carrying out method according to claim 1, comprising:
an adapter configured to receive the cuvette; and
a displacement element configured to be flow-connected to the cuvette to generate a flow to receive or eject the fluid sample.

18. A laboratory machine for carrying out the method according to claim 1, comprising:
a treatment space configured to receive the cuvette;
a pipetting device comprising a displacement element configured to be flow-connected to the cuvette to generate a flow to receive or eject the fluid sample, the pipetting device arranged in the treatment space to carry out at least one processing step on the fluid sample;
a movement device arranged so as to be movable in at least one first spatial direction of the treatment space, the movement device connected to the pipetting device such that the pipetting device is capable of being moved through the treatment space by the movement device;
a detection device arranged in the treatment space to analyze the fluid sample; and
an electronic control device signal-connected to the pipetting device, the movement device and the detection device.

19. The laboratory machine according to claim 18, wherein the detection device comprises a radiation source configured to irradiate the fluid sample with the primary radiation and a detector configured to receive receiving a secondary radiation originating from the fluid sample.
